(19) United States
(12) Patent Application Publication
(10) Pub. No.: US 2012/0031421 A1
(43) Pub. Date: Feb. 9, 2012

(54) Method For Achieving and Semi-Permanently Retaining a Hairstyle

(76) Inventors: Randy Purnell WASHINGTON, West Chester, OH (US); Jose Antonio Carballada, Cincinnati, OH (US); Stephanie Lee Davis, Liberty Twp., OH (US); Faiz Fiesal Sherman, Warren Twp., OH (US); Grant Edward Anders Striemer, Hamilton, OH (US)

(21) Appl. No.: 13/204,296

(22) Filed: Aug. 5, 2011

Related U.S. Application Data
(60) Provisional application No. 61/371,305, filed on Aug. 6, 2010.

(51) Int. Cl. A45D 7/06; A61Q 5/06

(52) U.S. Cl. 132/206; 132/221

(57) ABSTRACT

In one aspect, a method for achieving and semi-permanently retaining a hairstyle is provided. This method allows achieving a hairstyle and recovering it after shampooing hair. In another aspect, a kit comprising a film-forming composition and a coating composition is provided.

### CROSS REFERENCE TO RELATED APPLICATION

This application claims the benefit of U.S. Provisional Application No. 61/371,305 filed Aug. 6, 2010.

### FIELD OF THE INVENTION

In one aspect, a method for achieving and semi-permanently retaining a hairstyle is provided. This method allows achieving a hairstyle and recovering it after shampooing hair. In another aspect, a kit comprising a film-forming composition and a coating composition is provided.

### BACKGROUND OF THE INVENTION

Styling hair is about achieving a specific hairstyle e.g. achieving curls from straight hair. Usually, hair may be styled using non-permanent and/or permanent methods. Permanent methods—or permanent waves—usually comprise the steps of applying onto hair a composition comprising a reducing agent, putting the hair in shape e.g. by using rollers, and then applying a composition comprising an oxidative agent. Such methods by chemically-modifying the internal hair fibers allow obtaining long-lasting effects i.e. over several months. However, such methods are time-consuming and often damage hair. In addition, such methods show little flexibility so that any need and/or wish for changing hairstyle would require conducting again a “permanent” wave onto hair, being time-consuming and further damaging hair. Non-permanent methods usually comprise the step of applying onto hair a styling composition i.e. a composition comprising a hair fixative polymer. Hair fixative polymers are already commercially available. For example, 13^{th} Edition of Personal Care Product Council's International Cosmetic Ingredient Dictionary and Handbook lists available fixative polymers classified as “hair fixatives” i.e. ingredients which impart hair-holding or style-retention properties to hair. Hair fixative polymers may be anionic, non-ionic, cationic or amphoteric polymers. Such methods allow achieving versatile hairstyle that would last for a few hours or at most till the next shampoo treatment. Whenever a user needs and/or wishes to have the same hairstyle for a longer period of time, and after each shampoo step, he would need to apply again a styling composition and to re-shape the hair.

None of the above methods allows achieving a hairstyle that may be retained and/or recover after at least one shampoo treatment e.g. after at least five shampoo treatments so that the user would not need to re-shape hair after each shampoo but would still have the opportunity to change hairstyle after some time, without needing to use stringent hair treatment such as “permanent wave”.

There is a need therefore for providing a method for achieving and semi-permanently retaining and/or recovering hairstyle. There is also the need for providing a method for obtaining a hairstyle exhibiting resistance to shampoo treatments. Particularly, there is a need for providing a method for retaining and/or recovering hairstyle after at least one shampoo treatment, particularly after three shampoo treatments, more particularly after five shampoo treatments. In addition, there is a need for providing a method for achieving and retaining and/or recovering hairstyle, without damaging hair and/or without compromising the feel.

### SUMMARY OF THE INVENTION

In one aspect, the present invention relates to a method for achieving and semi-permanently retaining a hairstyle, this method comprising the successive steps of:
providing and treating hair with a film-forming composition (A) comprising a hair fixative polymer being selected from the group consisting of (A.1) a water-soluble hair fixative polymer, (A.2) an emulsified water-insoluble hair fixative polymer, or mixtures thereof; and, a cosmetically acceptable carrier;
putting hair in shape;
drying shaped hair from about 1 min to about 120 min at a temperature from about ambient temperature to about 200° C.;
providing and coating hair with a composition (B) comprising (B.1) a water-based silicone emulsion; and, a cosmetically acceptable carrier;
   wherein the fixative polymeric film, obtained by treating hair with composition (A), has a delamination time of at least 30 sec.

In a further aspect, the present invention relates to a styling kit, this kit comprising:
a first composition being a film-forming composition (A) comprising a hair fixative polymer being selected from the group consisting of (A.1) a water-soluble hair fixative polymer, (A.2) an emulsified water-insoluble hair fixative, or mixtures thereof; and, a cosmetically acceptable carrier
a second composition (B) comprising (B.1) a water-based silicone emulsion; and, a cosmetically acceptable carrier.
   wherein, upon use, said first composition forms onto hair a fixative polymeric film having a delamination time of at least 30 sec.

### BRIEF DESCRIPTION OF THE DRAWINGS

FIG. 1 shows the picture of the right side of a doll head.

FIG. 2 shows the picture of the left side of a doll head.

FIG. 3 shows the picture of front-top side of a doll head.

### DETAILED DESCRIPTION OF THE INVENTION

As used herein, the term “ambient temperature” means about 25° C. under 1 atm of pressure.

As used herein, the term “fixative polymeric film” means a film which is obtained after a film-forming composition comprising a hair fixative polymer has been applied to hair and let drying. As used herein, the term “cosmetically acceptable carrier” means a medium which is compatible with keratin materials including hair and skin.

In one aspect, the present invention relates to a method for achieving and semi-permanently retaining a hairstyle, this method comprising the successive steps of providing and treating hair with a film-forming composition (A); putting hair in shape; drying shaped hair; and providing and coating hair with a composition (B); wherein the fixative polymeric film, obtained by treating hair with composition (A), has a delamination time of at least 30 sec. These steps are preferably conducted on the same day. This method is a cosmetic method. It is a durable semi-permanent styling method.

The inventors have surprisingly found that a method comprising a step of treating hair with a composition (A) comprising a specific hair fixative polymer (A.1) and/or a specific hair fixative polymer (A.2), followed by shaping and drying steps, and then a step of coating hair with a composition (B) comprising a water-based silicone emulsion (B.1) allows achieving a semi-permanent hairstyle i.e. a durable hairstyle. This semi-permanent hairstyle is retained and/or recovered after at least one shampoo treatment, particularly after three shampoo treatments, more particularly after five shampoo treatments. Besides the increased durability of the hairstyle, the inventors have also found that this method prevents clumping of hair and/or improves post-shampoo detangling of hair and feel. In addition, the inventors have found that this method increases the water-resistance of hairstyle, increases the ease of style and/or increases the manageability of the hairstyle after shampoo. Without wishing to be bound by any theory, it is believed that the above benefits are due to the steps conducted, their sequence as well as the specific components used incl. the fixative polymers (A.1) and/or (A.2) and the component (B.1). Particularly, the hair fixative polymers are specifically chosen so that a fixative polymeric film having a sufficient delamination time, i.e. of at least 30 sec, is obtained. Indeed, the application of a composition comprising the polymers (A.1) and/or (A.2) and the subsequent shaping of hair allow achieving a hairstyle, this hairstyle being retained and/or recovered by specifically drying the hair and then applying a composition comprising component (B.1). Without wishing to be bound by theory, it is believed that a polymer (A.1) and/or (A.2) once applied onto the hair fibers forms a fixative polymeric film which exhibit sufficient mechanical strengths to sustain the subsequent steps of the present method. It is also believed that component (B.1) once applied onto hair forms a hydrophobic coating onto the hair fibers onto which the hair fixative polymers (A.1) and/or (A.2) have already formed fixative polymeric film. This hydrophobic coating—or layer—exhibits water-resistance and avoids therefore, or at least slows down, shampoo treatments for removing fixative polymers deposited onto hair i.e. the fixative polymeric film. This results in a durable hairstyle.

The present invention relates to a method comprising a treatment step, a shaping step, a drying step and a coating step. The treatment step consists in providing and treating hair with a film-forming composition (A) comprising a hair fixative polymer selected from the group consisting of (A.1) a water-soluble hair fixative polymer, (A.2) an emulsified water-insoluble hair fixative polymer, or mixtures thereof; and a cosmetically acceptable carrier. After the treatment step, the composition (A) forms a fixative polymeric film onto hair. The polymer (A.1) and/or (A.2) is selected so that the fixative polymeric film, obtained by treating hair with composition (A), has a delamination time of at least 30 sec.

The composition (A) may comprise a specific water-soluble hair fixative polymer (A.1). This polymer is suitable for obtaining a fixative polymeric film having a delamination time of at least 30 sec. As used herein, the term “water-soluble” means that 0.1 wt % of a polymer or its neutralized version can be dissolved in water at ambient temperature. This includes polymers which can be dissolved in water at a temperature greater than the ambient temperature and/or by using conventional pH adjusting agents as far as 0.1 wt % of these polymers or their neutralized version are dissolved in water when the solution is cooled down to ambient temperature. As used herein, the term “delamination time” means the time necessary for the hair array/arrangement/bundle treated with composition (A), i.e. the hair onto which a fixative polymeric film is formed, to break while being immersed in water and/or shampoo. The fixative polymeric film comprises a delamination time of at least about 30 sec, preferably from about 30 sec to about 4 days, more preferably from about 2 min to about 60 min The delamination time may be measured according to the method described hereafter.

The inventors have surprisingly found that using specific water-soluble polymers being subsequently hydrophobically coated, are beneficial as it allows delivering hair shape/styling retention through multiple washes, while also allowing removing the coating without the need for using organic solvents. Additionally, the water-soluble film i.e. the fixative polymeric film trapped under the hydrophobic coating can reheal during the shampoo steps as the polymer absorbs enough moisture to soften and reform the film in the regions that have experience mechanical failure. Particularly, it is essential for polymer (A.1) to allow obtaining a fixative polymeric film exhibiting a delamination time of at least about 30 sec. It has been found that such delamination time ensures that the fixative polymeric film exhibits sufficient mechanical properties and film integrity to withstand the coating step i.e. application of water-based silicone emulsion (B.1) and the subsequent shampoo step(s) without showing significant loss of mechanical properties. This also ensures that the polymeric film exhibits sufficient resistance to water and shampoos. In contrast, when the hair fixative polymers are chosen so that it is obtained a fixative polymeric film having a delamination time below 30 sec, the method does not allow obtaining a hairstyle exhibiting sufficient shampoo resistance and therefore does not allow achieving and semi-permanently retaining and/or recovering hairstyle.

The hair fixative polymer (A.1) may be selected from the group consisting of cationic, anionic, non-ionic, amphoteric fixative polymers, or mixtures thereof. In one embodiment, polymer (A.1) is selected from the group consisting of cationic fixative polymers, amphoteric fixative polymers, or mixtures thereof.

The cationic fixative polymers may be selected from the group consisting of fixative polymers containing primary, secondary, tertiary and/or quaternary amine groups forming part of the polymer chain or directly connected thereto, and having a weight-average molecular weight of from about 500 to about 5,000,000, preferably from about 1000 to about 3,000,000, and more preferably from about 10,000 to about 1,000,000 g/mole.

Suitable cationic fixative polymers may be homopolymers or copolymers comprising at least one of the following units of formula (IX) to (XII):

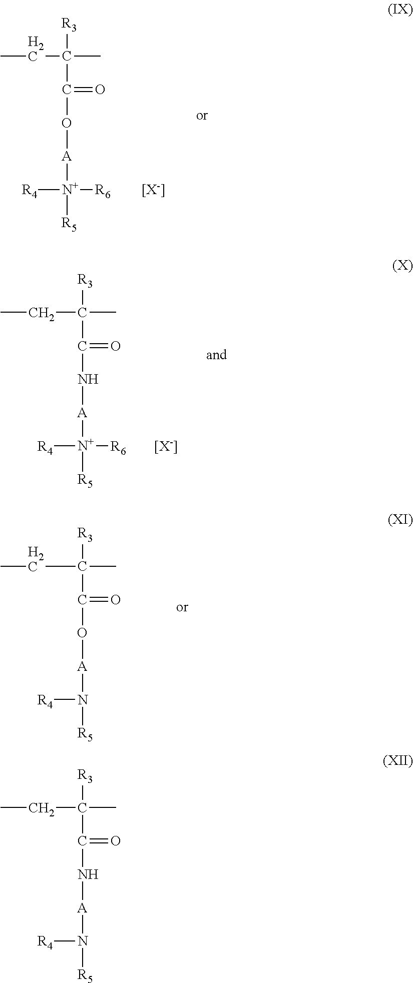

wherein R₃ denotes a hydrogen atom or a CH₃ radical; A is a linear or branched alkyl group of 1 to 6 carbon atoms or a hydroxyalkyl group of 1 to 4 carbon atoms; R₄, R₅ and R₆, which are identical or different, represent an alkyl group having from 1 to 18 carbon atoms or a benzyl radical; X denotes a methosulphate anion or a halide such as chloride or bromide. These copolymers may comprise one or more monomer units being selected from the group consisting of acrylic or methacrylic esters (e.g. acrylates, methacrylates), diacetone acrylamides, acrylamides and methacrylamides substituted on the nitrogen with C¹-C⁶ lower alkyls, acrylic or methacrylic acids or esters thereof, vinyllactams such as vinylpyrrolidone or vinylcaprolactam, vinyl esters, and mixtures thereof. Commercially available polymers are for example vinylpyrrolidone/dimethylamino ethylmethacrylate, vinylpyrrolidone/vinylcaprolactam/dimethylamino ethylmethacrylate tertpolymer, vinylpyrrolidone/dimethylamino propyl methacrylamide (Styleze CC10 from ISP), vinylpyrrolidone/dimethylamino propyl methacrylamide/quarternized dimethylamino propyl methacrylamide tertpolymer (Styleze W10 and Styleze W20, Polyquaternium 55 from ISP), vinylpyrrolidone/vinylcaprolactam/dimethylamino propylmethacrylamide (Aquaflex SF-40 from ISP), vinylpyrrolidone/vinylcaprolactam/dimethylamino propylmethacrylamide/quarternized dimethylamino propylmethacrylamide tetrapolymer, methacrylate/vinylcaprolactam/vinylpyrrolidone terpolymers.

The cationic fixative polymers may also be selected from fixative polymers being quaternized polysaccharides like celluloses, preferably cellulose derivatives grafted with a water-soluble monomer in the form of quaternary ammonium, more preferably hydroxyalkylcelluloses such as hydoxymethyl-, hydoxyethyl- and hydroxypropylcelluloses reacted with an epoxy substituted by a trimethyl ammonium group. Such materials are commercially available under the tradenames JR 400, JR 125, JR 30M, LR 400, and/or LR 30M by Amerchol. The cationic fixative polymers may also selected from fixative polymers being homopolymers or copolymers containing at least one vinylimidazole or quaternized vinylimidazole monomer unit. These copolymers may also comprise one or more monomer units which may be selected from acrylic or methacrylic esters or amides (e.g. acrylates, methacrylates), diacetone acrylamides, acrylamides and methacrylamides substituted on the nitrogen with C¹-C⁶ lower alkyls, acrylic or methacrylic acids or esters thereof, vinyllactams such as vinylpyrrolidone or vinylcaprolactam, and vinyl esters. Such materials are commercially available under the INCI names/tradenames: vinylpyrrolidone/acrylamide/vinyl imidazole/quarternized vinyl imidazole (Luviquat Supreme i.e. polyquaternium 68 from BASF Corporation); vinylpyrrolidone/methacrylamide/vinyl imidazole copolymer (Luviset Clear from BASF Corporation). The cationic fixative polymers may also be selected from the group consisting of chitosan, its salts thereof, or mixtures thereof, preferably chitosan acetate, lactate, glutamate, citrate, gluconate or pyrrolidonecarboxylate. Chitosan is a linear polysaccharide composed of β-(1-4)-linked D-glucosamine and N-acetyl-D-glucosamine Commercially available polymers are Derivat XII and Flonac N(S) from Nippon Suisan, and Kytamer PC from Amerchol. In a preferred embodiment, the cationic fixative polymer (A.1) is selected from the group consisting of chitosan, its salts thereof, or mixtures thereof.

The nonionic fixative polymer may be selected from the group consisting of vinyl acetate homopolymers, copolymers of vinyl acetate and of acrylic ester, polyvinyl chloride homopolymers; copolymers of polyethylene and of maleic anhydride; polyurethanes; homopolymers of pyrrolidone; copolymers of PVP and of vinyl acetate; polysaccharides including polysugars such as Pullulan from Hayashibara; hydroxyalkylcellulose; water soluble polyurethanes; and, mixtures thereof.

The anionic fixative polymer may be selected from the group consisting of polymers containing groups derived from carboxylic acid and/or sulphonic acid and having a weight-average molecular weight from about 500 to about 5,000,000, preferably from about 1000 to about 3,000,000, and more preferably about 10,000 to about 1,000,000. The carboxylic groups may be provided by unsaturated mono- or dicarboxylic acid monomers such as those corresponding to the formula (XIII):

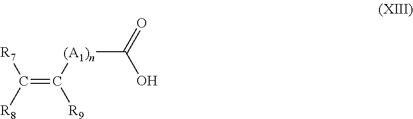

in which n is an integer from 0 to 10; A₁ denotes a methylene group, optionally linked to the carbon atom of the unsaturated group or to the neighboring methylene group when n is greater than 1 via a hetero atom such as oxygen or sulphur, R₇ denotes a hydrogen atom, or a phenyl or benzyl group; R₈ denotes a hydrogen atom or a C₁-C₆ lower alkyl or carboxyl group; and, R₉ denotes a hydrogen atom, a C₁-C₆ lower alkyl group or a —CH₂—COOH, phenyl or benzyl group. Lower alkyl radical preferably means a group having 1 to 6 carbon atoms and in particular methyl and ethyl. Commercially available anionic fixative polymers are for example: homo- or copolymers of acrylic or methacrylic acid or salts; copolymers of acrylic acid and of C₁-C₄ alkyl methacrylate and terpolymers of vinylpyrrolidone, copolymers of acrylic acid and of C₁-C₂₀ alkyl methacrylate such as lauryl methacrylate; methacrylic acid/ethyl acrylate/tert-butyl acrylate terpolymers; copolymers derived from crotonic acid; vinyl acetate/crotonic acid (90/10) copolymer; copolymers derived from C₄-C₈ monounsaturated carboxylic acids or anhydrides; and, polyacrylamides containing carboxylate groups.

Anionic fixative polymers comprising sulphonic groups may be selected from polymers comprising vinylsulphonic, styrenesulphonic, naphthalenesulphonic, acrylamidoalkylsulphonic units, or combinations thereof. These polymers may be selected from the group consisting of polyvinylsulphonic acid salts having a weight-average molecular weight of from about 1000 to about 100,000, copolymers with an unsaturated comonomer such as acrylic or methacrylic acids and esters thereof, as well as acrylamide or derivatives thereof, vinyl ethers and vinylpyrrolidone; sodium salt of polystyrenesulphonic acid having a weight-average molecular weight of about 500,000 and of about 100,000; polyacrylamide sulphonic acid salts such as polyacrylamidoethylpropanesulphonic acid salts.

In a preferred embodiment, the anionic fixative polymer is selected from acrylic acid copolymers such as the acrylic acid/ethyl acrylate/N-tert-butylacrylamide terpolymer, copolymers derived from crotonic acid such as vinyl acetate/vinyl tert-butylbenzoate/crotonic acid terpolymers and crotonic acid/vinyl acetate/vinyl neododecanoate terpolymers, or mixtures thereof.

The amphoteric fixative polymer may be selected from polymers containing units A and B randomly distributed in the polymer chain, where A denotes a unit derived from a monomer containing at least one basic nitrogen atom and B denotes a unit derived from an acidic monomer containing one or more carboxylic or sulphonic groups, or alternatively A and B can denote groups derived from zwitterionic monomers of carboxybetaines or of sulphobetaines.

Particularly, the amphoteric fixative polymer may be a polymer resulting from the copolymerization of a monomer derived from a vinyl compound bearing a carboxylic group such as, more particularly, acrylic acid, methacrylic acid, maleic acid or alpha-chloroacrylic acid and of a basic monomer derived from a substituted vinyl compound containing at least one basic atom such as, more particularly, dialkylaminoalkyl methacrylate and acrylate, dialkylaminoalkylmethacrylamide and acrylamide.

This polymer may be a polymer containing units derived from at least one monomer selected from acrylamides or methacrylamides substituted on the nitrogen with an alkyl radical, at least one acidic comonomer containing one or more reactive carboxylic groups, and at least one basic comonomer. The N-substituted acrylamides or methacrylamides may be substituted with alkyl radicals containing from 2 to 12 carbon atoms, particularly N-ethylacrylamide, N-tert-butylacrylamide, N-tert-octylacrylamide, N-octylacrylamide, N-decylacrylamide and N-dodecylacrylamide as well as the corresponding methacrylamides. The acidic comonomer containing one or more reactive carboxylic groups may be selected from acrylic acid, methacrylic acid, crotonic acid, itaconic acid, maleic acid, fumaric acid, alkyl monoesters having 1 to 4 carbon atoms of maleic acid or fumaric acids, anhydrides thereof, or mixtures thereof. The basic comonomer such as esters containing primary, secondary, tertiary and quaternary amine substituents of acrylic and methacrylic acids and the product of quaternization of dimethylaminoethyl methacrylate with dimethyl or diethyl sulphate. Particularly, the basic comonomer is selected from the groups consisting of aminoethyl, butylaminoethyl, N-N′-dimethylaminoethyl, N-tert-butylaminoethyl methacrylates, or mixtures thereof. Commercially available materials are octylacrylamide/acrylates/butylaminoethyl methacrylate copolymer sold under the name Amphomer by Akzo Nobel.

This polymer may be a polymer containing zwitterionic units of formula (XIV):

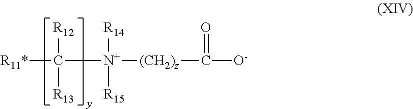

in which R₁₁ denotes a polymerizable unsaturated group such as an acrylate, methacrylate, acrylamide or methacrylamide group, y and z represent an integer from 1 to 3, R₁₂ and R₁₃, which are identical or different, represent a hydrogen atom, methyl, ethyl or propyl and R₁₄ and R₁₅, which are identical or different, represent a hydrogen atom or an alkyl radical such that the sum of the carbon atoms in R₁₄ and R₁₅ does not exceed 10. This polymer may also further comprise units derived from non-zwitterionic monomers such as dimethyl or diethylaminoethyl acrylate or methacrylate or alkyl acrylates or methacrylates, acrylamides or methacrylamides or vinyl acetate. Commercially available materials are for example a copolymer of methyl methacrylate/methyl dimethylcarboxymethylammonioethylmethacrylate (Diaformer Z301 by Clariant).

This polymer may be a polymer containing zwitterionic units of formula alkyl amine oxide acrylates like acrylates/stearyl acrylate/ethylamine oxide methacrylate copolymer (Diaformer Z-632N from Mitsubishi Chemical America, Inc).

This polymer may also be selected from the group consisting of chitosan-derived polymer, polymers derived from the N-carboxyalkylation of chitosan, such as N-carboxy-methyl chitosan or N-carboxybutyl chitosan, or mistures thereof.

This polymer may also be selected from the group consisting of copolymers of (C₁-C₅)alkyl vinyl ether/maleic anhydride partially modified by semiamidation with an N,N-dialkylaminoalkylamine such as N,N-dimethylaminopropylamine or by semiesterification with an N,N-dialkanolamine. These copolymers may comprise further vinyl monomers such as vinylcaprolactam.

In a preferred embodiment, the amphoteric fixing polymers is selected from the group consisting of a polymer containing units derived from at least one monomer selected from acrylamides or methacrylamides substituted on the nitrogen with an alkyl radical, at least one acidic comonomer containing one or more reactive carboxylic groups, and at least one basic comonomer, a polymer comprising zwitterionic units. Preferred commercially available materials are octylacrylamide/acrylates/butylaminoethyl methacrylate copolymers (Amphomer, Amphomer by Akzo Nobel) and copolymers of methyl methacrylate/methyl dimethylcarboxymethylammonioethylmethacrylate (Diaformer Z301 by Clariant).

The composition (A) may comprise an emulsified water-insoluble hair fixative polymer (A.2). This polymer is suitable for obtaining a fixative polymeric film having a delamination time of at least 30 sec. As used herein, the term “emulsified” means that the water-insoluble hair fixative polymer, or composition comprising it thereof, is insoluble in the carrier and is therefore dispersed into said carrier (continuous phase). As used herein, the expression “water-insoluble” means that the hair fixative polymer in its solid or liquid form cannot be uniformly incorporated (mixed into, dissolved) or dispersed into water without using surface active materials.

The polymer (A.2) may be selected from the group consisting of water-insoluble hair fixative polyurethanes, water-insoluble hair fixative acrylates, or mixtures thereof. Commercially available emulsified water-insoluble fixative polymers (A.2) are for example Baycusan C1001, C1002, C1003, and C1004 from Bayer.

The composition (A) may comprise from about 0.1 to about 10%, preferably from about 0.5 to about 8%, more preferably from about 2 to about 7%, of a hair fixative polymer selected from the group consisting of the polymer (A.1), the polymer (A.2), or mixtures thereof; by total weight of the composition (A).

The composition (A) also comprises a cosmetically acceptable carrier. This carrier may be an aqueous carrier, preferably water. The carrier may also be a volatile hydroalcoholic carrier, preferably a mixture of water and ethanol. The volatile alcohol may be an organic solvent such as a C₁-C₆ alkanol; preferably ethanol, n-propanol, isopropanol, n-butanol, amyl alcohol, and mixtures thereof; more preferably a C₂-C₄ monohydric alcohol such as ethanol, isopropanol, and mixtures thereof.

The composition (A) may also comprise any additional components conventionally used in hair care or personal care products. These additional components are physically and chemically compatible with the components described above, particularly the hair fixative polymers (A.1) and (A.2). These additional components preferably do not unduly impair the product stability, aesthetics or performance. Nonlimiting examples of such additional components are disclosed in International Cosmetic Ingredient Dictionary, Fifth Edition, 1993, and the 13^{th} Edition of Personal Care Product Council's International Cosmetic Ingredient Dictionary and Handbook, both of which are incorporated by reference herein in their entirety. Particularly, the composition (A) may comprise an additional hair fixative polymer being different from water-soluble hair fixative polymer (A.1) and/or an emulsified water-insoluble hair fixative polymer (A.2). For example, the composition (A) may comprise a polymeric quaternary ammonium salt of hydroxyethylcellulose quaternized with diallyldimethyl ammonium chloride i.e. polyquaternium-4. The composition (A) may comprise emulsifiers, surfactants, conditioning actives including moisturizers and emollients, sunscreens, anti-free-radical agents, sequestering agents, antioxidants, preserving agents, acidifying or basifying agents, fragrances, dyestuffs, modified or non-modified non-volatile silicones, reducing agents, plasticizers, neutralizers, or mixtures thereof. The composition (A) may also comprise any further components known or otherwise effective for use in hair care or personal care products. The composition (A) may comprise from about 0% to about 25%, preferably from about 0.05% to about 25%, more preferably from about 0.1% to about 15%, of additional components by total weight of the composition.

The shaping step consists in putting hair in shape, preferably using a suitable device. This step is conducted after the treatment step, preferably immediately or at least within 1 to 60 min after the treatment step. After the shaping step, shaped treated hair have a specific and defined hairstyle. Shaping of hair may be obtained merely by passing fingers through hair so that to give a hairstyle. For example, hair strands may be twisted onto fingers in order to impart curls to them. This step may also be achieved using rollers wherein hair are divided in strands and each strand is rolled onto rollers and maintained in a fixed position using any suitable fixing means such as clips or pins. This step may also be achieved using a curling iron.

The drying step consists in drying shaped treated hair from about 1 min to about 120 min at room temperature and up to 200° C. This step is conducted after the shaping step, preferably immediately or at least within about 1 to about 60 min after the shaping step. Alternatively, the drying step is conducted simultaneously to the shaping step. The drying step may be conducted using any suitable device such as a blow dryer, a drying hood, a curling iron, a straight iron, or combinations thereof. Alternatively or complementary, the drying step may be conducted merely by leaving hair to naturally dry at room temperature for a few hours, preferably from about 1 to about 24 hours, more preferably from about 2 to about 10 hours.

The coating step consists in providing and coating dried, shaped, treated hair with a composition (B) comprising (B.1) a water-based silicone emulsion; and, a cosmetically acceptable carrier.

This step is conducted after the drying step, preferably immediately or at least within about 1 min to about 60 min. Particularly, this step is conducted before the hairstyle is drastically decreased or lost. Indeed, the inventors have surprisingly found that the shape retention and durability is achieved only when the order of the steps is not arbitrary i.e. when the coating step is conducted after the treatment and shaping steps. Indeed, when both compositions (A) and (B) are applied simultaneously or if the composition (B) is applied before composition (A), it is not obtained a satisfactory shape retention and durability, if any. After the coating step according to the present invention, hair is coated with a substantially continuous hydrophobic layer obtained from the water-based silicone emulsion (B.1).

The water-based silicone emulsion (B.1) is an oil-in-water emulsion. This oil-in-water emulsion comprises a polydimethylsiloxane (P) having aminoalkyl groups and having an amine number of at least 0.1 meq/g of polydimethylsiloxane (P), composed of units of the general formula (I)

R¹ₐR²_{b}SiO_{(4-a-b)/2} (I),

in which

R¹ are independently optionally halogen-substituted alkyl radicals having 1-40 carbon atoms, or are —OR or —OH radicals;

R are independently optionally halogen-substituted alkyl radicals having 1-40 carbon atoms;

R² are independently aminoalkyl radicals of the formula II

—R³—NR⁴R⁵ (II);

R³ are independently divalent hydrocarbon radicals having 1-40 carbon atoms;

R⁴ are independently monovalent hydrocarbon radicals having 1-40 carbon atoms or are H;

R⁵ are independently radicals of the formula III

—(R⁶—NR⁴)ₓR⁴ (III);

R⁶ independently are divalent radicals of the formula IV

—(CR⁴R⁴—)_{y} (IV);

x is 0 or a value from 1 to 40; y is 1 or 2; a is 0, 1, 2 or 3; b is 0, 1, 2 or 3; and, a+b on average is from 1.5 to 2.5;
and, not more than 9 mol % of the radical R¹ being OH or OR.

The alkyl radicals R¹ and R may be linear, cyclic, branched, saturated or unsaturated. The alkyl radicals R¹ and R preferably have 1-18 carbon atoms, more preferably have 1-6 carbon atoms, still more preferably is methyl radical or ethyl radical. Preferred halogen substituents are fluorine and chlorine. Particularly preferred radicals R¹ are the methyl radical, methoxy radical, ethoxy radical or —OH.

The divalent hydrocarbon radicals R³ may be halogen-substituted, linear, cyclic, branched, aromatic, saturated or unsaturated. The radicals R³ preferably have 1 to 6 carbon atoms, more preferably are alkylene radicals, and still more preferably are propylene radicals. Preferred halogen substituents are fluorine and chlorine.

The monovalent hydrocarbon radicals R⁴ may be halogen-substituted, linear, cyclic, branched, aromatic, saturated or unsaturated. The radicals R⁴ preferably have 1 to 6 carbon atoms, and more preferably are alkyl radicals. Preferred halogen substituents are fluorine and chlorine. Particularly preferred substituents R⁴ are methyl, ethyl, cyclohexyl and H.

In the polydimethylsiloxanes, b preferably has the value 0 or 1, and a+b preferably has an average value of from 1.9 to 2.2. In the polydimethylsiloxanes, x is preferably 0 or a value from 1 to 18, most preferably from 1 to 6.

Radicals R² are preferably —CH₂N(R⁴)₂, —(CH₂)₃N(R⁴)₂ and —CH₂)₃N(R⁴)(CH₂)₂N(R⁴)₂.

The polydimethylsiloxane (P) is composed of at least 3, in particular at least 10, units of the general formula (I).

The ratio of a to b is chosen so that the polydimethylsiloxane (P) has an amine number of at least 0.1 meq/g of polydimethylsiloxane (P), preferably at least 0.6 meq/g of polydimethylsiloxane (P). The amine number of the polydimethylsiloxane (P) is preferably not more than 7 meq/g of polydimethylsiloxane (P).

The viscosity of the polydimethylsiloxane (P) is preferably from 1 to 100,000 mPa·s, in particular from 10 to 10,000 mPa·s, at 25° C.

The component (B.1) preferably comprises about 100 parts by weight of said polydimethylsiloxane (P).

The component (B.1) may also comprise an auxiliary. This auxiliary is preferably selected from the group of monoalcohols, polyalcohols, their ethers, or mixtures thereof, wherein these auxiliaries have a boiling or boiling range of not more than 260° C. at 0.10 MPa.

The component (B.1) may also comprise a protonating agent. This protonating agent is preferably selected from the group consisting of monoprotic or polyprotic, water-soluble or water-insoluble, organic or inorganic acid, most preferably selected from the group consisting of formic acid, acetic acid, sulfuric acid, hydrochloric acid, citric acid, or mixtures thereof. The protonating agent is preferably added in an amount of from 0.05 to 2 mol of acidic proton per mole of basic nitrogen atom of the radical R².

The component (B.1) may also comprise water, particularly demineralized or non-demineralized water, preferably demineralized water.

The component (B.1) may also comprise a MQ silicone resin. The MQ silicone resin preferably contains at least 80 mol %, preferably at least 95 mol %, of units of the general formulae (V) and (VI)

R⁷₃SiO_{1/2} (V),

SiO_{4/2} (VI),

in which R⁷ are optionally halogen-substituted hydrocarbon radicals having 1-40 carbon atoms or H, —OR or —OH radicals, and the ratio of the units of the general formulae (V) and (VI) is from 0.5 to 2.0, preferably from 0.5 to 1.5, and not more than 3% by weight, preferably not more than 2.5% by weight, of the radicals R⁷ are —OR and —OH.

The remaining units of the MQ silicone resin are preferably units of the general formulae (VII) and (VIII)

R⁷₂SiO_{2/2} (VII),

R⁷SiO_{3/2} (VIII).

The monovalent hydrocarbon radicals R⁷ may be halogen-substituted, linear, cyclic, branched, aromatic, saturated or unsaturated. The radicals R⁷ preferably have 1 to 6 carbon atoms, and alkyl radicals and phenyl radicals are particularly preferred. Further halogen substituents are fluorine and chlorine. Particularly preferred substituents R⁷ are methyl, ethyl, phenyl and H. Component (B.1) may comprise from 1 to 200 parts by weight, preferably from 5 to 100 parts by weight of MQ silicone resin.

The component (B.1) comprises not more than 5, preferably not more than 3, more preferably not more than 1, still more preferably not more that 0,1, parts by weight of emulsifier. The component (B.1) is preferably emulsifier-free.

The polydimethylsiloxanes (P) and emulsions or dispersions thereof are described in US 2006/0041026 A1 which is hereby incorporated by reference. An oil-in-water emulsion of polydimethylsiloxanes (P) suitable for the invention is sold under the trademark Wacker® HC 303 VP by Wacker-Chemie AG (Germany).

The composition (B) may comprise from about 0.5 to about 30%, preferably about 1% to about 15%, more preferably about 2 to about 8%, of the water-based silicone emulsion (B.1), by total weight of the composition.

The composition (B) also comprises a cosmetically acceptable carrier, preferably water, more preferably demineralized water.

The present invention may comprise further steps selected from the group consisting of a further drying step, a pre-treatment step, a rinsing step, a shampooing step, a conditioning step, or combinations thereof.

The further drying step may consist in drying treated shaped coated hair from about 20 min to about 240 min at a temperature from ambient temperature and up to about 80° C. This step is conducted after immediately or at least within about 1 to about 60 min after the coating step or after the rinsing step if any. This further drying step may be conducted using any suitable device as detailed above. The inventors have surprisingly found that conducting a further drying step is beneficial in order to increase the shape retention and durability of the treatment.

The pre-treatment step may consist in wetting hair with a composition (C). The treatment step is conducted immediately after or at least within about 1 to about 15 min after this pre-treatment step. The composition (C) may comprise any suitable cosmetic component, and an aqueous carrier. Preferably, the composition (C) is water.

The rinsing step may consist in rinsing treated, shaped, coated hair with a composition (D). This rinsing step is conducted immediately after or at least within about 1 to about 15 min after the coating step. The composition (D) may comprise any suitable cosmetic component, and an aqueous carrier. Preferably, the composition (D) is water.

The shampooing step may consist in applying a shampoo composition (E) onto hair. This shampooing step may be conducted immediately after, within about 1 to about 60 min after the coating step, or later. The composition (E) may be any conventional shampoo composition.

The conditioning step may consist in applying a conditioning composition (F) onto hair. This shampooing step may be conducted immediately after, within about 1 to about 60 min after the coating step, or later. The composition (F) may be any conventional conditioning composition. Any of compositions (C), (D), (E) and (F) are substantially free of any polymer (A.1), polymer (A.2) and component (B.1).

The present invention is also preferably free from any step of providing and applying a shampoo composition after applying onto hair the composition (A) and before coating hair with the composition (B). Indeed, the inventors have found that conducting an intermediate shampooing step between the treatment step and the coating increases the wash-out of the hair fixative polymer i.e. the fixative polymeric film and therefore reduces the shape retention and the durability.

The present invention is also preferably free of any step selected from the group consisting of providing and applying a composition comprising a reducing agent in a suitable carrier, providing and applying a composition comprising an oxidative agent, and combination thereof.

In a second aspect, the present invention relates to a styling kit, this kit comprising:
a first composition being a film-forming composition (A) comprising a hair fixative polymer being selected from the group consisting of (A.1) a water-soluble hair fixative polymer, (A.2) an emulsified water-insoluble hair fixative, or mixtures thereof; and, a cosmetically acceptable carrier; and
a second composition (B) comprising (B.1) a water-based silicone emulsion and a cosmetically acceptable carrier;
   wherein, upon use, said first composition forms onto hair a fixative polymeric film having a delamination time of at least 30 sec.

The first and the second compositions may be packaged in independent containers. Alternatively, the first and the second compositions may be packaged together in one container in which these compositions are physically separated to each other. Particularly, both compositions may be packaged in a multi-compartment container.

In one preferred embodiment, the present invention relates to a method for achieving and semi-permanently retaining a hairstyle, this method comprising the successive steps of:
providing and treating hair with a film-forming composition (A) comprising a hair fixative polymer being (A.1) a water-soluble hair fixative polymer; and, a cosmetically acceptable carrier;
putting hair in shape using a suitable device;
drying shaped hair from about 1 min to about 120 min at a temperature from about ambient temperature to about 200° C.;
providing and coating dried, shaped hair with a composition (B) comprising (B.1) a water-based silicone emulsion; and, a cosmetically acceptable carrier;
   wherein the fixative polymeric film, obtained by treating hair with composition (A), has a delamination time of at least 30 sec; and,
   wherein said water-based silicone emulsion (B.1) comprises a polydimethylsiloxane (P) having aminoalkyl groups and having an amine number of at least 0.1 meq/g of polydimethylsiloxane (P), composed of units of the general formula (I)

R¹ₐR²_{b}SiO_{(4-a-b)/2} (I),

in which R¹ are independently optionally halogen-substituted alkyl radicals having 1-40 carbon atoms, or are —OR or —OH radicals; R are independently optionally halogen-substituted alkyl radicals having 1-40 carbon atoms; R² are independently aminoalkyl radicals of the formula —R³—NR⁴R⁵; R³ are independently divalent hydrocarbon radicals having 1-40 carbon atoms; R⁴ are independently monovalent hydrocarbon radicals having 1-40 carbon atoms or are H; R⁵ are independently radicals of the formula —(R⁶—NR⁴)ₓR⁴; R⁶ independently are divalent radicals of the formula —(CR⁴R⁴—)_{y}; x is 0 or a value from 1 to 40; y is 1 or 2; a is 0, 1, 2 or 3; b is 0, 1, 2 or 3; and, a+b on average is from 1.5 to 2.5; and, not more than 9 mol % of the radical R¹ being OH or OR.

### EXAMPLE 1

### Selection of the Hair Fixative Polymer (A.1) and/or (A.2)

Materials

All percentages are expressed by total weight of the composition.

The following five compositions (A) were tested:
Composition 1 comprising 3.0% Derivat XII (Chitosan from Nippon Suisan), 0.5% Softcat (Polyquaternium-67 by Dow Personal Care), qsp 100% water
Composition 2 comprising 2.0% Derivat XII (Chitosan from Nippon Suisan), 1.0% Celquat H-100 (Polyquaternium 4 by Akzo Nobel), qsp 100% water
Composition 3 comprising 4.0% Derivat XII (Chitosan from Nippon Suisan), qsp 100% water
Composition 4 comprising 3.0% Celquat H-100 (Polyquaternium-4 from Akzo Nobel), qsp 100% water
Composition 5 comprising 3% Luviquat Supreme (BASF), qsp 100% water
   Methodology for Measuring Delamination Time (sec)

Delamination time is the time it takes for the polymeric film on the treated hair to break when immersed in water with a known applied weight. Four 6 inch (13.2 cm) low lift hair switches are used for each samples. 0.25 g of composition (A) is applied to the hair to the front and back side of the hair switch. The material is spread through the hair evenly with the fingers and combed three times. After the solution is applied, the switches are dried at 65° C. for at least 1 hour. The hair is allowed to be cooled at least 5 minutes before measurement. The assembly consists of a 20 g weight applied to one end of the hair using a clip and the other end attached to a lowering bar. The hair tress is then placed in water and the time it takes for the treated hair switch to separate is recorded.

### Results

The delamination time of the fixative polymeric film has been measured according to the methodology detailed hereinbefore. The measurement obtained are detailed in the table I below.

TABLE I

| | Delamination | |
|---|---|---|
| Compositions | time (sec) | Deviation (sec) |
| 1 | 173.00 | 34.90 |
| 2 | 99.40 | 20.00 |
| 3 | 151.56 | 30.46 |
| 4 | 26.50 | 3.34 |
| 5 | 4.50 | 2.65 |

Compositions 1 to 3, which are according to the present invention, allow obtaining a fixative polymeric film having a delamination time of at least 30 sec.

Compositions 4 and 5, which are comparative compositions, allow obtaining a fixative polymeric film having a delamination time of less than 30 sec.

### EXAMPLE 2

### Obtaining of a Durable, Semi-permanent Hairstyle

### Materials

Composition (A) comprises 3.0% chitosan (Derivat from Nippon Suisan Kaisha, Ltd.), 0.5% Softcat SL-5, qsp 100% water by weight of the total composition.

Comparative composition (A) comprises 3% polyquarternium 4, qsp 100% water, by weight of the total composition.

Composition (B) comprises 8% Wacker HC303, qsp 100% water by weight of total composition. Doll head comprises straight, dark brown hair from Wimex A20067 and having an average length from 8 to 12 inches (20.3 to 30.5 cm).

### Protocol—Preparation of Hair

Immersion—The doll head is wet with running water for 1 min for 10 min (temperature of about 38° C.).

Shampooing—8 ml of shampoo (Pantene® Ice Shine Shampoo) is applied on whole head. The shampoo is then gently massaged on hair with fingers for 1.5 min.

Rinsing—Hair is thoroughly rinsed with water (about 36° C.) by using showerhead for 2.5 min per half head.

Protocol—Treatment and coating of hair according to the present invention (left part of the doll head)

Centre parting—Hair are parted down the middle.

Treatment—10 g of composition (A) is applied distributed evenly with fingers. The hair is combed 4 times with a wide-toothed comb.

Shaping (1)—The hair is wrapped on rollers (2.5 cm diameter) for a total of about 14 rollers per half-head and maintained with pins.

Drying (1)—Heat is applied on the rolled hair using a drying hood for 40 min at 55° C.

Shaping (2)—Rollers are removed and dried additional 10 min and switches are scrunched both vertically and horizontally until the switches are separated into smaller sections.

Coating—12 g of composition (B) is applied evenly on hair (12g for left-half head) using a pump spray and smooth gently.

Drying (2)—Each rolled switches is blow-dried with diffuser for 2 min The hair is finger combed for final hair style.

### Protocol—Treatment Hair (Comparative—Right Part of the Doll Head)

It is also conducted the treatment, shaping (1), drying (1) and shaping (2) steps as detailed above for the left half head. In contrast, the coating step and the drying step (2) are not conducted.

### Protocol—Performance Wash

Shampooing—4 ml of shampoo (Pantene® Ice Shine Shampoo) is applied on half head. Hair is gently massaged with fingers for 1.5 min

Rinsing—Hair is thoroughly rinsed with water (about 36° C.) by using showerhead for 2.5 min Hair are then gently pressed together with hands to drain-off water before wrapping the doll head into a towel and pressing to absorb water.

Combing—Hair is gently finger combed to mechanically refresh style.

Drying—Hair is blow-dried with diffuser (about 45° C. for 10 min)

The performance wash may be repeated as often as needed.

### Results

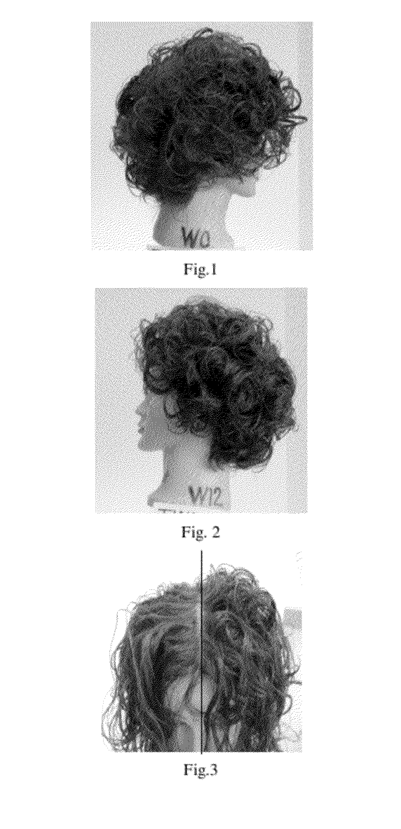

Following the protocols detailed above, the right half head has been treated so that a polymeric film is formed onto hair. The left half head has been treated so that a polymeric film is formed onto hair and then a hydrophobic coating has been formed. As shown in FIG. 1 and FIG. 2, following the treatment (both left and right half head) and the coating (left half head), both half heads exhibit similar initial hairstyles.

Following shampooing both half heads twice (see “performance wash ” above), the left half head (according to invention) exbihits a significant higher retention of the hairstyle versus the right half head (comparative). Specifically, more curl definition is found at the root of the hair.

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm.”

Every document cited herein, including any cross referenced or related patent or application, is hereby incorporated herein by reference in its entirety unless expressly excluded or otherwise limited. The citation of any document is not an admission that it is prior art with respect to any invention disclosed or claimed herein or that it alone, or in any combination with any other reference or references, teaches, suggests or discloses any such invention. Further, to the extent that any meaning or definition of a term in this document conflicts with any meaning or definition of the same term in a document incorporated by reference, the meaning or definition assigned to that term in this document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. A method for achieving and semi-permanently retaining a hairstyle, this method comprising the successive steps of:
providing and treating hair with a film-forming composition (A) comprising a hair fixative polymer being selected from the group consisting of (A.1) a water-soluble hair fixative polymer, (A.2) an emulsified water-insoluble hair fixative polymer, or mixtures thereof; and, a cosmetically acceptable carrier;
putting hair in shape;
drying shaped hair from about 1 min to about 120 min at a temperature from about ambient temperature to about 200° C.;
providing and coating hair with a composition (B) comprising (B.1) a water-based silicone emulsion; and, a cosmetically acceptable carrier;
wherein the fixative polymeric film, obtained by treating hair with composition (A), has a delamination time of at least 30 sec.

2. The method, according to claim 1, wherein the successive steps are conducted on the same day.

3. The method, according to claim 1, further comprises the step of further drying hair from about 20 min to about 240 min at a temperature from about ambient temperature to about 80° C., after coating hair with said composition (B).

4. The method, according to claim 1, further comprises the step of wetting hair with a composition (C) before applying said composition (A) onto them.

5. The method, according to claim 1, further comprises the step of rinsing hair with a composition (D).

6. The method, according to claim 1, further comprises the step of applying a shampoo composition (E) onto hair.

7. The method, according to claim 1, further comprises the step of conditioning hair with a composition (F).

8. The method, according to claim 1, being free of any step of providing and applying a shampoo composition after applying onto hair said composition (A) and before coating hair with said composition (B).

9. The method, according to claim 1, being free of any step selected from the group consisting of providing and applying a composition comprising a reducing agent in a suitable carrier, providing and applying a composition comprising an oxidative agent, and combination thereof.

10. The method, according to claim 1, wherein the fixative polymeric film, obtained by treating hair with composition (A), has a delamination time from about 30 sec to about 4 days.

11. The method, according to claim 1, wherein the fixative polymeric film, obtained by treating hair with composition (A), has a delamination time from about 2 min to about 60 min.

12. The method, according to claim 1, wherein said water-soluble hair fixative polymer (A.1) is selected from the group consisting of cationic fixative polymers, anionic fixative polymers, non-ionic fixative polymers, amphoretic fixative polymers, or mixtures thereof.

13. The method, according to claim 1, wherein said emulsified water-insoluble fixative polymer (A.2) is selected from the group consisting of water-insoluble hair fixative polyurethanes, water-insoluble hair fixative acrylates, or mixtures thereof.

14. The method, according to claim 1, wherein said composition (A) comprises from about 0.1 to about 10% of a hair fixative polymer selected from the group consisting of the polymer (A.1), the polymer (A.2), or mixtures thereof; by total weight of the composition (A).

15. The method, according to claim 1, wherein said water-based silicone emulsion (B.1) is an oil-in-water emulsion comprising a polymethylsiloxane (P) having aminoalkyl groups and having an amine number of at least 0.1 meq/g of polydimethylsiloxane (P).

16. The method, according to claim 15, wherein said polydimethylsiloxane (P) having aminoalkyl groups and having an amine number of at least 0.1 meq/g of polydimethylsiloxane (P), and comprising units of the general formula (I)
R¹ₐR²_{b}SiO_{(4-a-b)/2} (I)
in which
R¹ are independently optionally halogen-substituted alkyl radicals having 1-40 carbon atoms, or are —OR or —OH radicals;
R are independently optionally halogen-substituted alkyl radicals having 1-40 carbon atoms;
R² are independently aminoalkyl radicals of the formula II
—R³—NR⁴R⁵ (II);
R³ are independently divalent hydrocarbon radicals having 1-40 carbon atoms;
R⁴ are independently monovalent hydrocarbon radicals having 1-40 carbon atoms or are H;
R⁵ are independently a radical of the formula III
—(R⁶—NR⁴)ₓR⁴ (III);
R⁶ independently are a divalent radical of the formula IV
—(CR⁴R⁴—)_{y} (IV);
X is 0 or a value from 1 to 40; y is 1 or 2; a is 0, 1, 2 or 3; b is 0, 1, 2 or 3; and, a+b on average is from 1.5 to 2.5;
and, not more than 9 mol % of the radical R¹ being OH or OR.

17. The method, according to claim 1, wherein said composition (B) comprises from about 0.5 to about 30% of the water-based silicone emulsion (B.1), by total weight of the composition.

18. A method for achieving and semi-permanently retaining a hairstyle, this method comprising the successive steps of:
providing and treating hair with a film-forming composition (A) comprising a hair fixative polymer being (A.1) a water-soluble hair fixative polymer; and, a cosmetically acceptable carrier;
putting hair in shape using a suitable device;
drying shaped hair from about 1 min to about 120 min at a temperature from about ambient temperature to about 200° C.;
providing and coating dried, shaped hair with a composition (B) comprising (B.1) a water-based silicone emulsion; and, a cosmetically acceptable carrier;
wherein the fixative polymeric film, obtained by treating hair with composition (A), has a delamination time of at least 30 sec; and,
wherein said water-based silicone emulsion (B.1) comprises a polydimethylsiloxane (P) having aminoalkyl groups and having an amine number of at least 0.1 meq/g of polydimethylsiloxane (P), composed of units of the general formula (I)
R¹ₐR²_{b}SiO_{(4-a-b)/2} (I),
in which R¹ are independently optionally halogen-substituted alkyl radicals having 1-40 carbon atoms, or are —OR or —OH radicals; R are independently optionally halogen-substituted alkyl radicals having 1-40 carbon atoms; R² are independently aminoalkyl radicals of the formula —R³—NR⁴R⁵; R³ are independently divalent hydrocarbon radicals having 1-40 carbon atoms; R⁴ are independently monovalent hydrocarbon radicals having 1-40 carbon atoms or are H; R⁵ are independently radicals of the formula —(R⁶—NR⁴)ₓR⁴ (III); R⁶ independently are divalent radicals of the formula —(CR⁴R⁴—)_{y}; x is 0 or a value from 1 to 40; y is 1 or 2; a is 0, 1, 2 or 3; b is 0, 1, 2 or 3; and, a+b on average is from 1.5 to 2.5; and, not more than 9 mol % of the radical R¹ being OH or OR.

19. A styling kit comprising:
a first composition being a film-forming composition (A) comprising a hair fixative polymer being selected from the group consisting of (A.1) a water-soluble hair fixative polymer, (A.2) an emulsified water-insoluble hair fixative, or mixtures thereof; and, a cosmetically acceptable carrier; and
a second composition (B) comprising (B.1) a water-based silicone emulsion and a cosmetically acceptable carrier;
wherein, upon use, said first composition forms onto hair a fixative polymeric film having a delamination time of at least 30 sec.
